(19) United States
(12) Patent Application Publication
(10) Pub. No.: US 2024/0370145 A1
(43) Pub. Date: Nov. 7, 2024

(54) WORK MACHINE WITH MAP-BASED COMMUNICATION SYSTEM

(71) Applicant: Deere & Company, Moline, IL (US)

(72) Inventors: Giovanni A. WUISAN, Epworth, IA (US); Scott J. BREINER, Dubuque, IA (US); Peter J. LOCKWOOD, Dubuque, IA (US)

(21) Appl. No.: 18/310,936

(22) Filed: May 2, 2023

(51) Int. Cl. G06F 3/04842; E02F 9/26; G06F 3/04817

(52) U.S. Cl. CPC G06F 3/04842; E02F 9/265; G06F 3/04817

(57) ABSTRACT

A user interface system generates a map display showing the location of a plurality of different work machines on the map display. A user interaction with the map display is detected and communication is established with another work machine at the worksite based on the detected user interaction.

### FIELD OF THE DESCRIPTION

The present description relates to mobile work machines. More specifically, the present description relates to a map-based communication system that can be used to communicate at mobile work machines.

### BACKGROUND

There is a wide variety of different types of mobile work machines, such as construction machines, agricultural machines, forestry machines, turf management machines, among others. For instance, construction work machines can include loaders, excavators, dump trucks, articulated machines, dozers, among a wide variety of other work machines.

It is not uncommon for a plurality of different work machines to be working at a given worksite. The operators of such work machines often communicate with one another. Current systems for providing communication among the operators of the different work machines on a worksite include a handheld transceiver (e.g., walkie-talkie), citizens band radios, and cellular telephones.

The discussion above is merely provided for general background information and is not intended to be used as an aid in determining the scope of the claimed subject matter.

### SUMMARY

A user interface system generates a map display showing the location of a plurality of different work machines on the map display. A user interaction with the map display is detected and communication is established with another work machine at the worksite based on the detected user interaction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram showing one example of a work machine architecture.

FIG. 2 is a pictorial illustration of one example of a map-based communication interface.

FIG. 3 is a block diagram showing one example of a work machine.

FIGS. 4A and 4B (collectively referred to herein as FIG. 4) show a flow diagram illustrating one example of the operation of a work machine in generating a map-based communication interface and performing a communication operation based on operator interaction with the map-based communication interface.

FIG. 5 is a block diagram showing one example of the work machine architecture deployed in a remote server architecture.

FIGS. 6, 7, and 8 show examples of mobile devices, that can be used in the architectures and machines illustrated in other FIGS.

FIG. 9 is a block diagram showing one example of a computing environment, which can be used in the architectures and machines illustrated in other FIGS.

### DETAILED DESCRIPTION

As discussed above, it is not uncommon for a plurality of different work machines to be working at the same worksite and for the operators of those work machines to communicate with one another. Currently, the modes of communication include citizens band radios (CB radios) and hand held transceivers. Also, some operators attempt to communicate with one another using cellular telephones. All of these types of communication have significant drawbacks.

For instance, at a given worksite, there may be three, four, or even more work machines operating. Individual communication can therefore be difficult when using a CB radio or handheld receiver. When an operator of a first work machine attempts to communicate with the operator of a second work machine using a CB radio or handheld transceiver, the communication from the operator of the first work machine can normally heard on the CB radios or handheld transceivers on all of the other work machines. This can result in the operators of all of the work machines receiving a great deal of communication that is not intended for them. This can reduce the likelihood that any individual operator will pay attention to communications, which may result in any given operator missing a communication that is intended for that operator. This can also increase the fatigue of the operators because they are attempting to listen for communications that are directed to them in such a noisy environment.

Similarly, when the operators of machines at a worksite attempt to communicate with one another using cellular telephones, this can also present challenges. For instance, a different person may be operating a particular work machine on different days, on different shifts, etc. However, an operator initiating a communication often wishes to communicate with the operator of a particular machine, instead of with a particular operator. For instance, the operator of a dump truck may wish to communicate with operator of a loader, regardless of the identity of that particular operator. Thus, even if an operator initiating a communication has the cellular telephone number for the other operators at the worksite, the operator initiating the communication may not know which operator is currently operating which machine. This can result in confusion, distraction, and inefficiencies in performing communication.

The present description thus proceeds with respect to a system that generates a map-based communication interface. A map display is generated for the operator of a work machine. The map display shows icons or other representations of other work machines operating at a worksite. The operator of a work machine can interact with the display (such as providing a touch gesture, a speech input, a point and click input, or another input) selecting one or more of the other work machines on the map display in order to initiate communication with those one or more of those machines. The map-based communication interface also includes buttons or other communication mechanisms for performing communication functionality such as initiating a call, answering a call, terminating a call, sending pre-defined or other messages or alerts, etc.

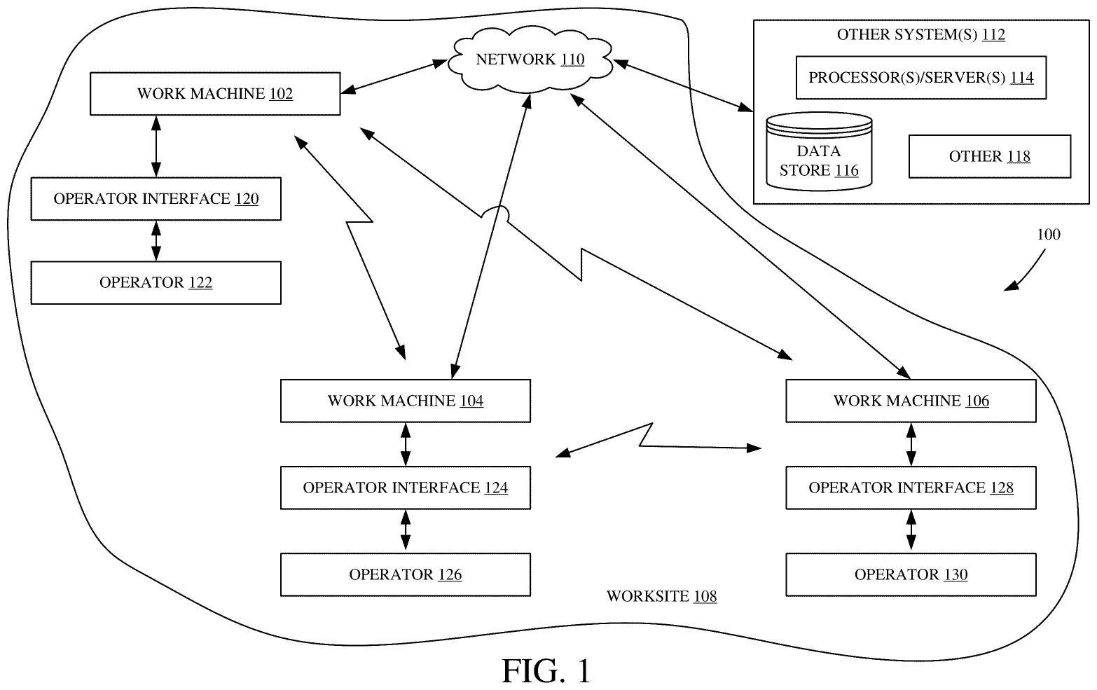

FIG. 1 is a block diagram of one example of a work machine architecture 100 in which a plurality of work machines 102, 104, and 106 are operating at a worksite 108. The work machines 102, 104, and 106 can communicate over a network 110 with the other work machines and with other systems 112. Other systems 112 can be manager systems, vendor systems, manufacturer systems, etc. In the example shown in FIG. 1, other systems 112 include one or more processors or servers 114, one or more data stores 116, and can include a wide variety of other functionality 118.

In the example shown in FIG. 1, work machine 102 is shown generating a user interface 120 for interaction by operator 122. Operator 122 can interact with operator interface 120 to control and manipulate work machine 102. Work machine 104 is shown generating operator interface 124 for interaction by operator 126. Operator 126 can interact with operator interface 124 in order to control and manipulate work machine 104. Work machine 106 is also shown generating an operator interface 128 for interaction by operator 130. Operator 130 interacts with operator interface 128 in order to control and manipulate work machine 106.

In the example shown in FIG. 1, the worksite 108 is a construction worksite so that work machines 102, 104, and 106 are construction work machines, such as dump trucks, excavators, loaders, dozers, or other work machines. It will be appreciated, however, that where worksite 108 is a different type of worksite (such as an agricultural worksite or a forestry worksite), then the work machines will be different types of work machines (such as agricultural work machines or forestry work machines).

In the example shown in FIG. 1, the work machines 102, 104, and 106 include communication systems so that the work machines can communicate with one another. In one example, the communication systems allow direct communication with one another. In another example, the work machines can communicate with one another over network 110 and/or in other ways.

As discussed above, it may be that an operator initiating communication may wish to communicate with the operator of one other work machine or with the operators of a plurality of the other work machines (e.g., all or a subset of the other work machines). For instance, where operator 126 is operating machine 104, operator 126 may wish to initiate communication with only operator 122 or with both operators 122 and 130. In prior systems, this has been very difficult.

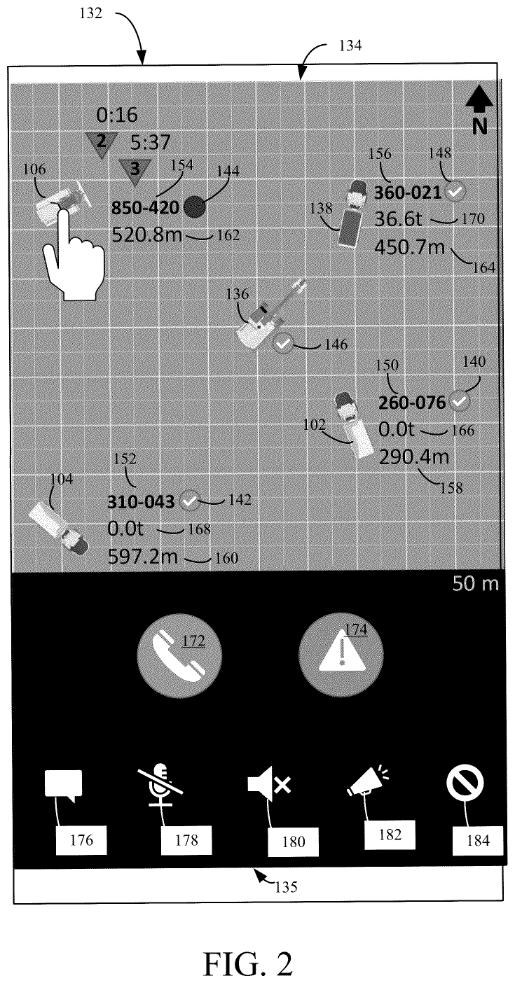

Thus, the present description proceeds with respect to a system that generates a map-based interface that can be used for conducting communications among the work machines. For instance, FIG. 2 shows one example of a map-based communication interface 132. Interface 132 has a map display portion 134 and communication control display portion 135. Map display portion 134 includes a display element corresponding to each work machine. In the example shown in FIG. 2, map display portion 134 has an icon or other graphical user interface element or other pictorial illustration or representation of the different work machines working at a particular worksite. Some items in FIG. 2 are similar to those shown in FIG. 1 and are similarly numbered. Therefore, map display portion 134 includes a display element corresponding to work machines 102, 104, and 106, as well as to work machines 136 and 138. In the example shown in FIG. 2, each display element (corresponding to each work machine) includes a user selection indicator that indicates whether the user has selected the corresponding work machine for communication. In the example shown in FIG. 2, the user selection elements include selection indicators 140, 142, 144, 146, and 148.

To select or de-select a work machine for communication, the user interacts with the display element corresponding to a work machine. In the example shown in FIG. 2, the display 132 is displayed on a touch sensitive screen so that the user simply needs to touch the display element corresponding to a work machine, in order to select or de-select that work machine for communication. In one example, the selection indicators 140-148 may be pre-selected, by default, or de-selected, by default. When the user touches the display element corresponding to a particular work machine, the state of the selection of that machine changes. In the example shown in FIG. 2, it can be seen that the user has selected work machines 102, 104, 146, and 148 for communication (the corresponding selection indicators show a checkmark) and the user has de-selected machine 106 for communication (because the corresponding selection indicator does not include a checkmark). These are just examples of selection indicators and other visual indica showing whether the work machine is selected or de-selected can be used as well.

Also, in the example shown in FIG. 2, the display elements corresponding to the different work machines include a machine identification portion and a distance portion. The machine identification portion includes a unique identifier (unique in the worksite) for each of the machines, while the distance portion identifies the distance that the particular work machine is located from the work machine on which display 132 is generated or from another known location. In the example shown in FIG. 2, it is assumed that display 132 is generated on work machine 136. Therefore, work machines 102, 104, 106, and 138 each have an identification portion 150, 152, 154, and 156, respectively, that identify the corresponding machine. Also, each display element includes a distance identifier 158, 160, 162, and 164, respectively that identifies the distance that the corresponding work machine is located from initiating work machine 136. Therefore, as illustrated in FIG. 2, work machine 102 is 290.4 meters from work machine 136. Work machine 104 is 597.2 meters, from machine 136 while work machine 106 is 520.8 meters and work machine 138 is 450.7 meters from machine 136.

FIG. 2 also shows that map display 134, as part of the display elements corresponding to the different work machines, displays pictorial illustrations of the different work machines, that represent the type of the different work machines. Thus, the pictorial illustrations depicted for work machines 102, 104, and 138 represent dump trucks while the pictorial illustration corresponding to work machine 106 represents a dozer and the pictorial illustration corresponding to work machine 136 represents an excavator. The display element corresponding to each of the work machines can include a wide variety of other information as well. That information can include machine characteristics. For instance, each of the dump truck work machines 102, 104, and 138 include load identifiers 166, 168, and 170, respectively. The load identifiers 166, 168, and 170 identify how much material each of the dump trucks 102, 104, and 138 is loaded with. It can be seen that trucks 102 and 104 are empty, while truck 138 is carrying 36.6 tons of material. Each of the display elements corresponding to the different work machines can include a wide variety of different or additional information, some of which is described elsewhere herein.

FIG. 2 also shows that the communication display portion 135 includes a plurality of actuators that can be actuated by the operator (such as by touching them, using a point and click device, a speech input, or another input mechanism) in order to perform communication functionality. For instance, button 172 can be actuated to initiate, answer, and/or end communication with the work machines selected in map display portion 134. For example, the operator can select work machines to receive communication and then actuate button 172 to initiate the communication. In one example, once communication is established, then it may be that button 172 changes to a disconnect button which can be actuated to disconnect or end communication. Button 174 can be used to send alert messages (e.g., predefined messages or alert messages entered vocally or alpha numerically by the operator) to the selected work machines. In one example, the operator can actuate button 174 and be presented with a list of pre-defined messages or alerts. The operator can select one of those messages or alerts and the selected message or alert is automatically sent to the selected work machines. Actuator 176 can be actuated to initiate a text message to the selected work machines (either predefined text message or message that can be authored by the operator using interface 132). Actuators 178 and 180 can be used to mute and unmute communications, and to place the communications on speaker mode. Button 182 can be actuated to select all of the work machines on the worksite display on map display 134 or to de-select all of those work machines. Button 184 can be actuated to close the display 132. These are only examples of the map-based communication interface functionality and additional or different functionality can be used as well.

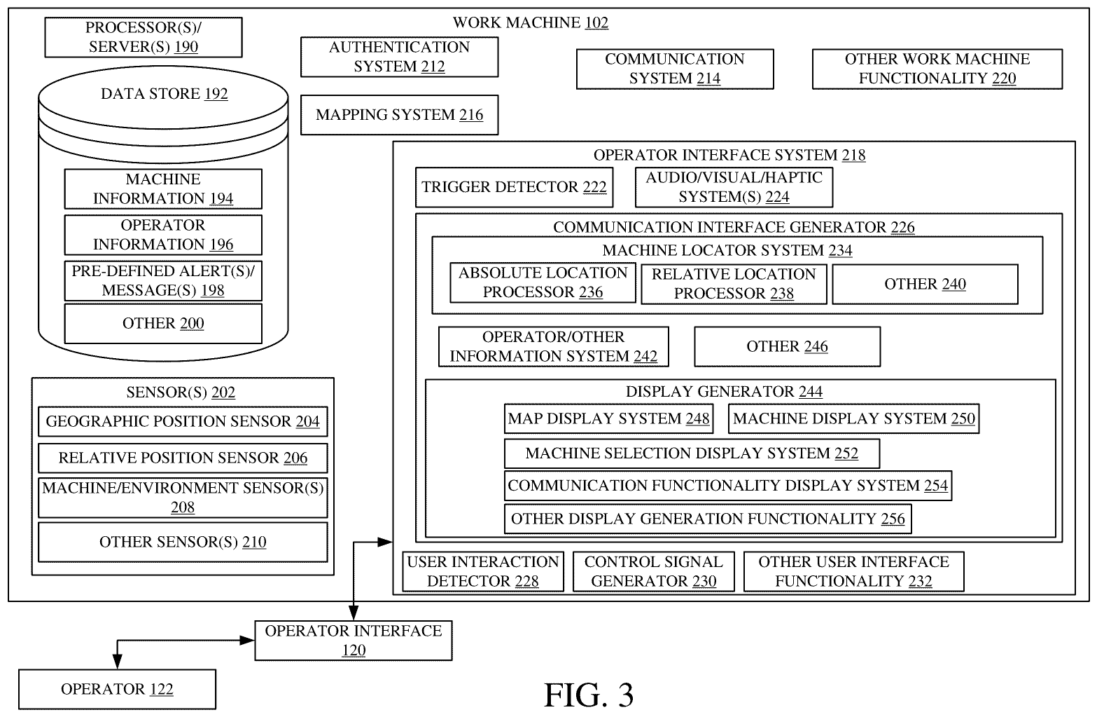

FIG. 3 is a block diagram showing one example of work machine 102, in more detail. All the work machines may have functionality that is similar to or different from that shown in FIG. 3. For the purposes of the present discussion it is assumed to be similar so that only work machine 102 is described in greater detail herein, but this is just one example. In the example shown in FIG. 3, work machine 102 can include one or more processors or servers 190, data store 192 (which can, itself, include machine information 194, operator information 196, pre-defined alerts/messages 198, and other items 200), sensors 202 (which can, themselves, include geographic position sensors 204, relative position sensors 206, machine/environment sensors 208, and other sensors 210), authentication system 212, communication system 214, mapping system 216, operator interface system 218, and other work machine functionality 220. Operator interface system 218 can include trigger detector 222, audio/visual/haptic systems 224, communication interface generator 226, user interaction detector 228, control signal generator 230, and a wide variety of other user interface functionality 232. Communication interface generator 226 can include machine locator system 234 (which can include absolute location processor 236, relative location processor 238, and/or other items 240), operator/other information system 242, display generator 244, and other items 246. Display generator 244 can include map display system 248, machine display system 250, machine selection display system 252, communication functionality display system 254, and other display generation functionality 256. Before describing the operation of work machine 102 in generating and using a map-based communication interface, a description of some of the items on work machine 102 and their operation will first be provided.

Machine information 194 in data store 192 can include information such as the unique identifier identifying work machine 102, a description of the type of work machine 102 (e.g., dump truck, articulated dump truck, excavator, loader, etc.) and any other machine information that may be used by or displayed on the map-based communication interface. For instance, when the map-based communication interface displays a display element corresponding to a dump truck, it may also display the capacity for the dump truck, the model of the dump truck, or any of a wide variety of other information corresponding to that work machine.

Operator interface information 196 may include the name of the operator that is currently operating work machine 102 and/or any of a wide variety of other operator profile information, such as the experience level of the operator, the operator's cellular telephone number, and/or other information. Pre-defined alerts/messages 198 may include a plurality of different pre-defined alert messages, text messages, voice messages, or other messages that can be sent through the map-based communication interface, once communication is established with another work machine.

Authentication system 212 can be used to authenticate an operator before the operator begins operating the work machine 102. For instance, the authentication system 212 may have the operator enter a personal identification number (PIN), or other authentication information that can be used to authenticate the operator. The authentication information may indicate whether the operator is authorized to operate this particular work machine 102 and/or any of a wide variety of other information. When authentication system 212 identifies and authenticates the operator, then authentication system 212 may use communication system 214 to download the operator information 196 and store that information in data store 192 for access by operator interface system 218. In another example, operator information 196 is already stored in data store 192 and authentication system 212 identifies the particular operator information 196 to use, that corresponds to the operator who authenticated himself or herself to authentication system 212.

Geographic position sensor 204 may be a global navigation satellite system (GNSS) receiver, a cellular triangulation system, a dead reckoning system, or any of wide variety of other location systems that can sense or identify the location of work machine 102 in a global or local coordinate system. Relative position sensor 206 may be a system that can identify the relative position of the work machines, relative to one another or relative to another known location. For instance, relative position sensor 206 can include a RADAR system, a LIDAR system, an optical sensing system, or any of a wide variety of other systems that can be used to sense the location of the work machines relative to one another, or relative to one or more other known locations. Machine/environment sensors 208 can be used to sense different characteristics of work machine 102 and/or the environment in which work machine 102 is operating. For instance, sensors 208 can sense the fuel level in work machine 102, the load being carried by work machine 102, the speed and heading or direction of work machine 102, the torque being applied by one or more different motors in work machine 102, the characteristics of the terrain over which 102 is traveling (e.g., wet, muddy, dry, sandy, etc.), and/or any of a wide variety of other machine or environment characteristics.

Sensors 202 generate sensor signals responsive to the item that the sensors are sensing, and provide those sensor signals to other items in work machine 102. Communication system 204 facilitates the communication of the items in work machine 102 with one another and with other work machines and other systems 112. Therefore, communication system 214 can include a controller area network (CAN) bus and bus controller, a half duplex communication system (such as a hand held transceiver, a CB radio, etc.), a full duplex communication system, a transmission control protocol (TCP) communication system, a TCP/IP system communication system, and/or any of a wide variety of other communication systems that communicate using the same or different communication protocols.

Mapping system 216 is illustratively a system that can receive an input from geographic position sensor 204 and locate work machine 102 on a map based upon that input. Mapping system 216 can also include a navigation system and/or any of a wide variety of other mapping system functionality.

Operator interface system 218 illustratively includes functionality for generating operator interface 120 for interaction by operator 122. Therefore, operator interface system 218 can include audio/visual/haptic system 224 and operator interface mechanisms such as a display device, a touch sensitive display device, a speaker and microphone (e.g., when speech recognition is provided), one or more joysticks, a steering wheel, pedals, levers, knobs, dials, a keyboard, a point and click device, or any of a wide variety of other user interface mechanisms that can provide an output to user 122 and/or receive inputs from user 122. In the example shown in FIG. 3, operator interface system 218 includes one or more audio/visual/haptic systems 224 that provide audio, visual and, and/or haptic outputs and receives inputs from operator 122. Trigger detector 222 can detect a trigger indicating that a map-based communication interface (such as interface 132 shown in FIG. 2) is to be generated and displayed as an operator interface 120 for interaction by operator 122. The trigger may be based on an operator input (such as operator 122 providing an input indicating that operator 122 wishes to perform communication) or an automatic trigger. The automatic trigger may be time-based, so that the map-based communication interface is updated and displayed periodically or otherwise intermittently to show the locations of the different work machines as they move about the worksite. In another example, the trigger may be an automated trigger that is location based so that when work machine 102 enters the worksite or is within a threshold distance of the worksite or is at another location, the map-based communication interface is automatically generated, or when work machine 102 has traveled a sufficient distance (such as 10 meters, 20 meters, etc.), then the map-based communication interface is generated and/or updated. The trigger detected by trigger detector 222, in order to generate or update the map-based communication interface, can be any of a wide variety of other triggers as well.

Once trigger detector 222 determines that a map-based communication interface should be generated, then communication interface generator 226 generates a representation of a map-based communication interface which can be displayed or otherwise output using audio/visual/haptic systems 224 or in another way. Machine locator system 234 locates machine 102 on the map generated by mapping system 216 and also identifies the location of the other machines that are to be displayed on the map-based communication interface. In one example, absolute location processor 236 can use communication system 214 to communicate with the other work machines to receive the location of those machines, from the machines themselves. Absolute location processor 236, for instance, can communicate with the other work machines to obtain their coordinates in the global or local coordinate system and use that, with mapping system 216, to determine the location of those work machines on the map-based based interface. In another example, machine locator system 234 can use other items such as relative position sensors 206 to locate the other work machines. Relative location processor 238 can use the input from relative position sensor 206 to determine the location where the other work machines should be placed on the map-based interface.

Operator/other information system 242 can be used to obtain the operator information and/or other information that is to be displayed on the map-based interface. For instance, system 242 can be used to control communication system 214 to communicate with the other work machines to obtain the operator information (e.g., profile information) corresponding to the operators of those work machines, and to obtain machine information corresponding to those work machines that is to be displayed on the map-based interface. Once the machines are located on the map-based interface, and once the other information (if any) is obtained, then display generator 244 can generate the map-based communication interface for interaction by operator 122.

Map display system 248 displays the map generated by mapping system 216 and machine display system 250 displays the display elements corresponding to the different work machines on the map display. Machine selection display system 252 displays the machine selection indicators (such as machine selection indicators 140-148 in FIG. 2) that indicate whether the corresponding work machines have been selected for communication. Communication functionality display system 254 displays the communication system functionality (such as communication display portion 135 shown in FIG. 2), and other display generation functionality 256 can generate a wide variety of other information on the map-based display.

Display generator 244 provides the output on an audio/visual/haptic system 224 as an operator interface 120 with which operator 122 can interact. User interaction detector 228 detects those user interactions and control signal generator 230 generates a control signal based on the user interactions. For instance, operator 122 can interact with the display by selecting a display element corresponding to one or more of the work machines with which to initiate communication. User interaction detector 228 can detect user interaction of a call actuator (such as call button 172) to initiate communication with the selected work machines. User interaction detector 228 can detect user interaction indicating that the user wishes to send a predefined text message or voice message or alert message to the selected work machines. User interaction detector 228 can detect a wide variety of other user interactions with the map-based communication interface as well. User interaction detector 228 generates an output indicative of the detected user interactions to control signal generator 230.

Control signal generator 230 generates control signals to control one or more other systems based upon the detected user interactions. For instance, control signal generator 230 can generate a control signal to control communication system 214 to initiate communication with the selected work machines (that are selected on the map-based communication interface). Control signal generator 230 can generate control signals to control communication system 214 to send a pre-defined text message, voice message, and/or alert message or other message to the selected work machines. Control signal generator 230 can generate any of a wide variety of other control signals to perform other control operations as well.

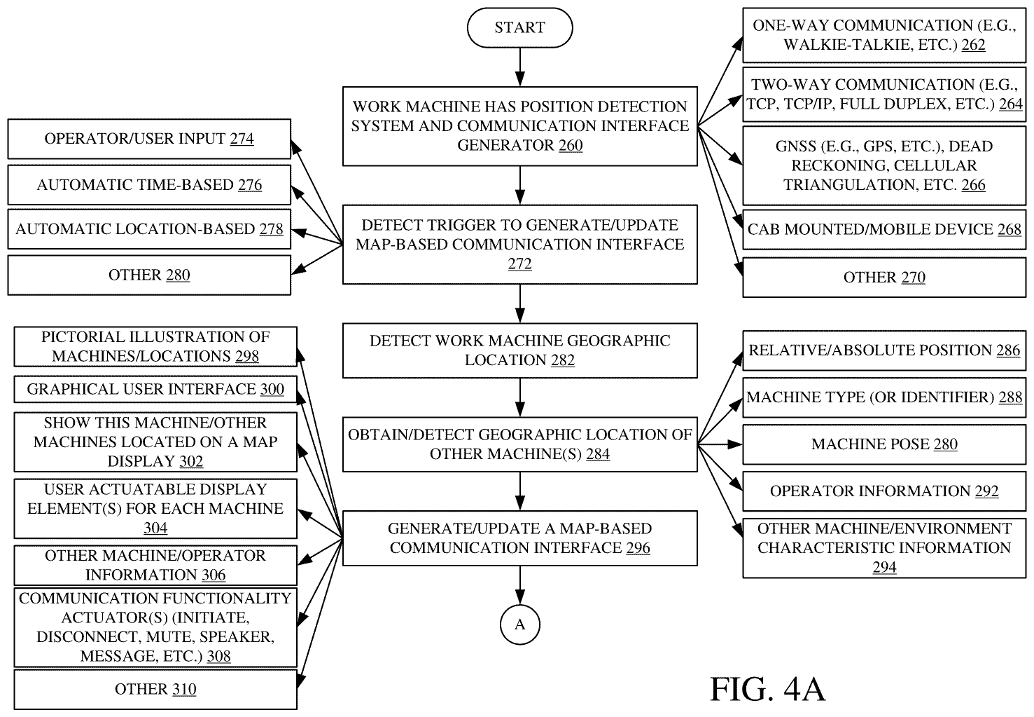

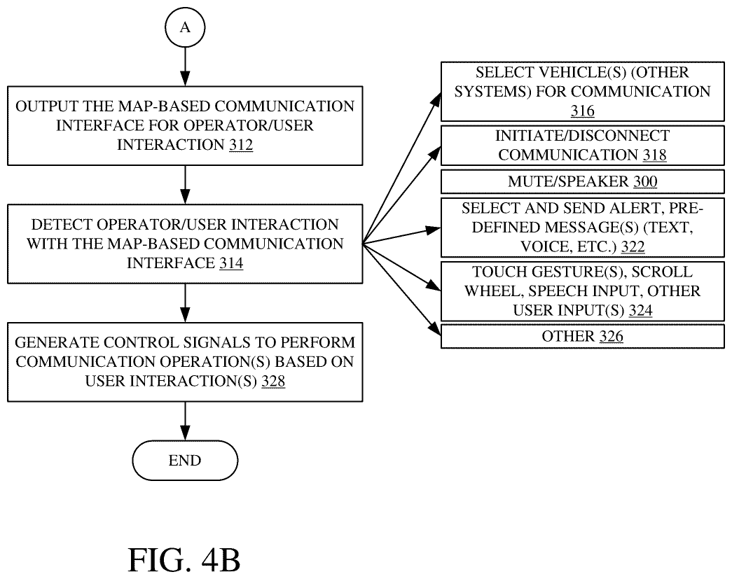

FIGS. 4A and 4B (collectively referred to herein as FIG. 4) show a flow diagram illustrating one example of the operation of a work machine (e.g., work machine 102) in generating a map-based communication interface and performing communication operations based upon detected user interactions with the map-based communication interface. In the example shown in FIG. 4, it is first assumed that work machine 102 has a geographic position detection system (such as geographic position sensor 204 and/or relative position sensor 206) and a map-based communication interface generator (such as generator 226 shown in FIG. 3), as indicated by block in the flow diagram of FIG. 4. In one example, the work machine has a one-way communication system 262 (such as a half-duplex, walkie-talkie, CB radio, etc.) communication system. The work machine 102 can have a two-way communication system 264 (such as a TCP, TCP/IP, full duplex, etc. communication system). The geographic position detection system can be a GNSS system, a dead reckoning system, a cellular triangulation system, etc., as indicated by block 266. The position detection system and communication interface generator can be mounted in the operator compartment of the machine, or on a mobile device, etc., as indicated by block 268 in the flow diagram of FIG. 4. The work machine can be configured with other items, in other ways as well, as indicated by block 270.

At some point, trigger detector 222 detects a trigger indicating that communication interface generator 226 is to generate or update a map-based communication interface, as indicated by block 272 in the flow diagram of FIG. 4. As mentioned above, the trigger can be an operator input from operator 122 indicating that the operator 122 wishes to initiate communication with another work machine. Detecting an operator/user input as the trigger is indicated by block 274 in the flow diagram of FIG. 4. In another example, the trigger may be an automatic time-based trigger, as indicated by block 276 in the flow diagram of FIG. 4. The trigger can be an automatic location-based trigger as well, as indicated by block 278, and as discussed elsewhere herein. The trigger can take a wide variety of other forms, as indicated by block 280 in the flow diagram of FIG. 4. By automatic it is meant, in one example, that the function or operation can be performed without further human involvement except, perhaps, to initiate or authorize the operation.

Machine locator 234 then detects the geographic location of work machine 102, and obtains or detects the geographic location of the other work machines on the worksite as well. Detecting geographic location of work machine 102 is indicated by block 282 in the flow diagram of FIG. 4, and detecting or obtaining the geographic location of the other work machines is indicated by block 284 in the flow diagram of FIG. 4. The absolute location processor 236 can be used to identify the absolute location (e.g., coordinates) of work machine 102 and/or the other work machines. The relative location processor 238 can be used to obtain the relative positions of the work machines, relative to one another, and/or relative to another known location. As discussed above, machine locator system 234 can use communication system 214 to communicate with the other work machines to obtain their location or system 214 can use relative position sensor 206 to detect the relative positions of the other work machines.

Obtaining the relative or absolute position of the various work machines is indicated by block 286 in the flow diagram of FIG. 4. It will also be noted that operator/other information system 242 can obtain other information, in addition to the machine locations. For instance, system 242 can obtain the machine type or identifier information that identities the type of machine and/or the unique identifier for the machine and/or other information, as indicated by block 288. System 242 can obtain the pose or heading of the various work machines, as indicated by block 290 as well as operator information for the operators of the various work machines, as indicated by block 292. System 242 can, of course, obtain a wide variety of other information (machine and/or environment characteristics) as well (such as machine settings information, machine status information, machine or environmental information), as indicated by block 294.

Display generator 244 then generates or updates a mapped-based communication interface, as indicated by block 296. As discussed elsewhere herein, map display system 248 can generate a display indicative of a map of the worksite while machine display system 250 generates a display element (such as a pictorial illustration) corresponding to the various work machines at their corresponding locations on the map display. Machine selection display system 252 displays the machine selection actuators. Communication functionality display system 254 generates the display of the actuators for performing communication functionality. Generating a pictorial illustration display element corresponding to work machines is indicated by block 298 in the flow diagram of FIG. 4. The display can be a graphical user interface 300 on which operator 122 interacts with graphical display elements on the display in order to perform communication operations. The map-based communication interface can show display elements corresponding to the current work machine 102 as well as other machines located on the map display, as indicated by block 302. The display elements corresponding to each work machine can be user actuatable display elements that can be actuated (e.g., selected or otherwise actuated) by the operator 122 using touch gestures, a point and click device, or any of a wide variety of other mechanisms that can be used to actuate (e.g., select and initiate or accept communication with) the display elements corresponding to the different work machines. Displaying the display elements as a user actuatable display elements is indicated by block 304 in the flow diagram of FIG. 4.

Machine information can also be displayed on the map-based communication interface, as indicated by block 306. Such information can be that described elsewhere herein. The map-based communication interface can also include actuators to perform communication functionality, such as to initiate communication, disconnect communication, mute a microphone, use speaker functionality, send messages or alerts, or perform any of a wide variety of other communication functionality, as indicated by block 308 in the flow diagram of FIG. 4. The map-based communication interface can display any of a wide variety of other information as well, as indicated by block 310.

Display generator 244 then outputs the map-based communication interface for operator or user interaction, as indicated by block 312. User interaction detector 228 then detects operator or user interactions with the map-based communication interface, as indicated by block 314. For instance, user interaction detector 228 can detect selection of the various vehicles or machines with which to initiate communication, as indicated by block 316. User interaction detector 228 detects operator interactions initiating or disconnecting communication with the other machines, over a communication channel, as indicated by block 318. User interaction detector 228 can detect operator interactions for muting or placing the communications on speaker mode, as indicated by block 320. User interaction detector 228 can detect operator interactions selecting, authoring, and/or sending alerts, pre-defined messages, and/or other text messages, and voice messages, and/or alerts, as indicated by block 322 in the flow diagram of FIG. 4. The user interaction detector 228 can detect an operator answering or accepting a call, dismissing or ending a call, or otherwise interacting with an incoming call. The interaction detector 228 can detect a wide variety of different user interactions such as touch gestures, scroll wheel inputs, voice inputs, or any of a wide variety of other user inputs and user interactions, as indicated by block 324. Other operator interactions with the map-based communication interface can be detected as well, as indicated by block 326 in the flow diagram of FIG. 4.

Control signal generator 230 then generates control signals to perform communication operations based upon the detected user interactions, as indicated by block 328 in the flow diagram of FIG. 4. For instance, those communication operations can be initiating a communication channel with the selected work machines, answering a call from another work machine, sending predefined or user-authored messages and/or alerts, or any of a wide variety other communication operations. When a call is answered, control signal generator 230 can generate control signals to control other functionality (such as to mute the radio, interrupt other calls, join conference calls, etc.).

It can thus be seen that the present system has proceeded with respect to a system that generates a map-based communication interface for conducting communications with other work machines. This enhances the efficiency and effectiveness of the communication system in that communications can be directed to only other selected work machines. In addition, the location of those machines can be easily identified and selected for communication. This enhances the operator experience, and enhances operational safety and efficiency.

The present discussion has mentioned processors and servers. In one example, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, they can be actuated using touch gestures. Also, where the device that displays them has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, generators, detectors, and/or logic. It will be appreciated that such systems, components, generators, detectors, and/or logic can be comprised of hardware items (such as processors and associated memory, or other processing components, some of which are described below) that perform the functions associated with those systems, components, generators, detectors, and/or logic. In addition, the systems, components and/or logic can be comprised of software that is loaded into a memory and is subsequently executed by a processor or server, or other computing component, as described below. The systems, components, generators, detectors, and/or logic can also be comprised of different combinations of hardware, software, firmware, etc., some examples of which are described below. These are only some examples of different structures that can be used to form the systems, components, generators, detectors, and/or logic described above. Other structures can be used as well.

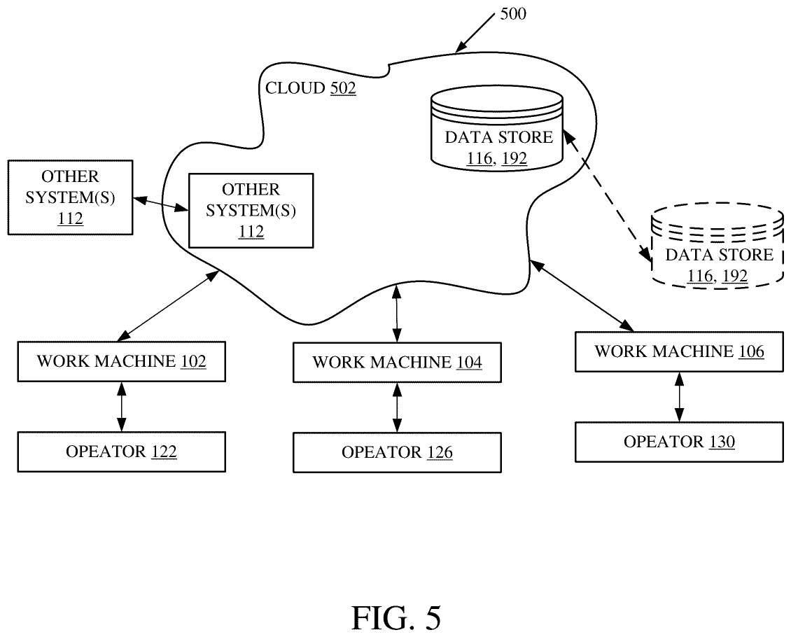

FIG. 5 is a block diagram of work machine 102, 104, and 106, shown in FIG. 1, except that they communicate with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided from a conventional server, or they can be installed on client devices directly, or in other ways.

In the example shown in FIG. 5, some items are similar to those shown in previous FIGS. and they are similarly numbered. FIG. 5 specifically shows that other systems 112 can be located at a remote server location 502. Therefore, machines 102, 104, and 106 access those systems through remote server location 502.

FIG. 5 also depicts another example of a remote server architecture. FIG. 5 shows that it is also contemplated that some elements of previous FIGS. are disposed at remote server location 502 while others are not. By way of example, data stores 116, 192 can be disposed at a location separate from location 502, and accessed through the remote server at location 502. Regardless of where the items are located, the items can be accessed directly by work machines 102, 105, and 106, through a network (either a wide area network or a local area network), they can be hosted at a remote site by a service, or they can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

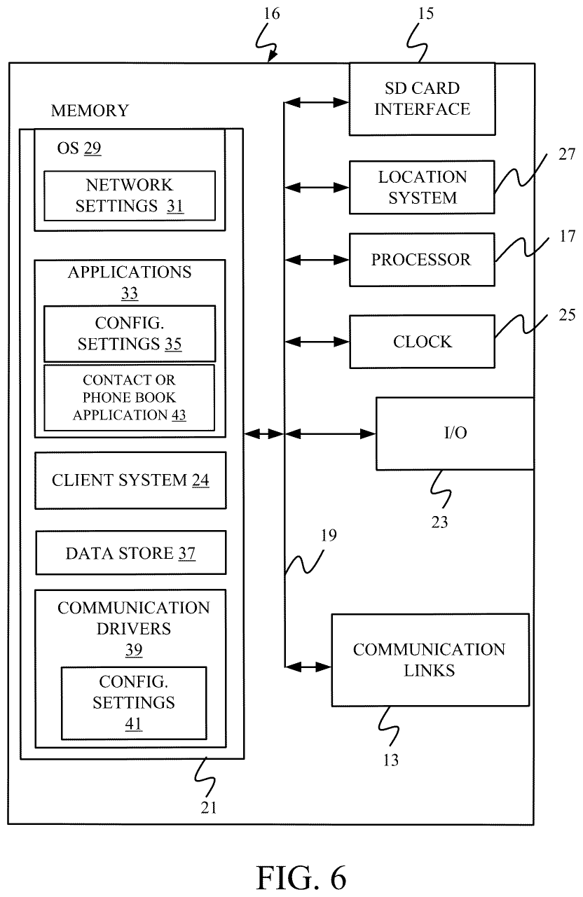

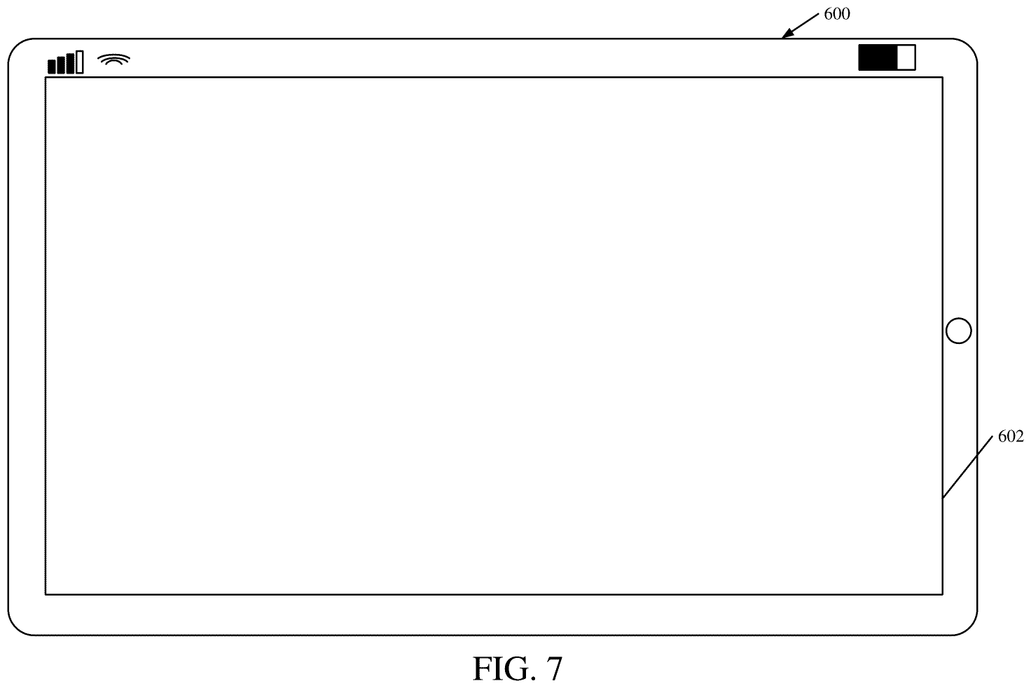

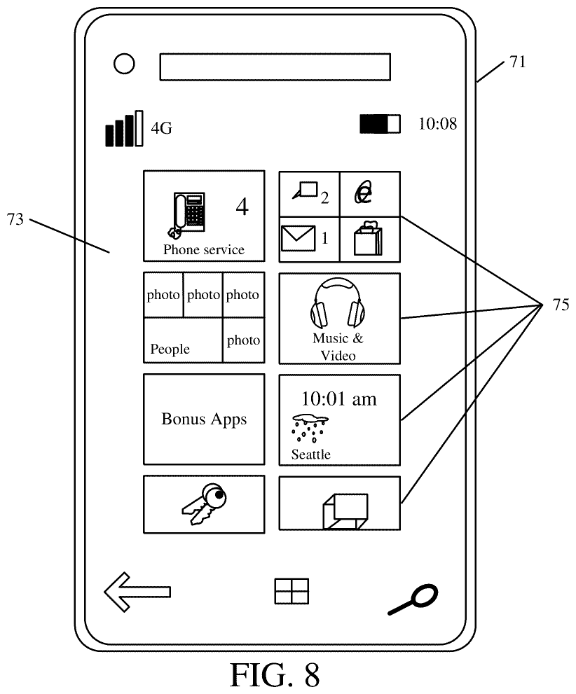

FIG. 6 is a simplified block diagram of one illustrative example of a handheld or mobile computing device that can be used as a user's or client's hand held device 16, in which the present system (or parts of it) can be deployed. For instance, a mobile device can be carried by an operator or deployed in the operator compartment of work machines 102, 104, and 106 for use in generating, processing, or displaying the map-based communication interface. FIGS. 7-9 are examples of handheld or mobile devices.

FIG. 6 provides a general block diagram of the components of a client device 16 that can run some components shown in previous FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. System 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 7 shows one example in which device 16 is a tablet computer 600. In FIG. 7, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

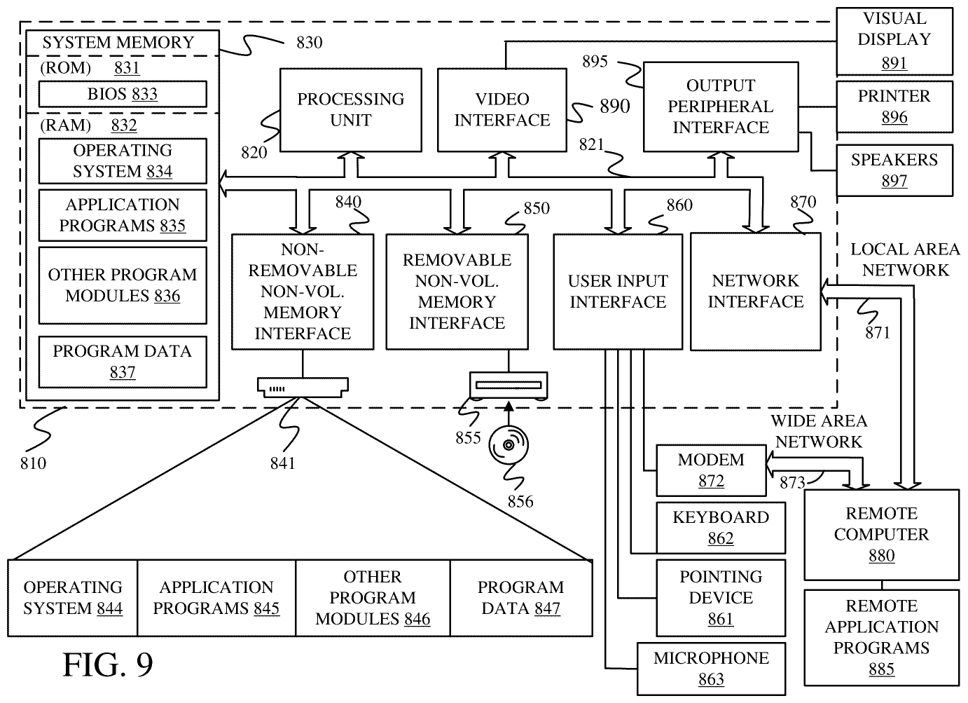

FIG. 9 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

FIG. 10 is one example of a computing environment in which elements of previous FIGS., or parts of it, (for example) can be deployed. With reference to FIG. 10, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network—CAN, local area network—LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 10 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
detecting a first location corresponding to a first work machine;
detecting a second location corresponding to a second work machine;
causing display, at the first work machine, of a first display element corresponding to the first work machine at the first location on a map display and a second display element corresponding to the second work machine at the second location on the map display:
detecting a user interaction with the second display element on the map display, the user interaction indicative of a selection input selecting the second work machine;
causing a display, at the first work machine, of a selection indicator display element on the map display based on the detected user interaction with the second display element; and
controlling a communication system at the first work machine to communicate with a communication system at the second work machine.

2. The method of claim 1 wherein controlling a communication system comprises:
controlling the communication system at the first work machine to establish a full duplex communication link with the communication system at the second work machine.

3. The method of claim 1 and further comprising:
detecting a third location of a third work machine; and
causing display of a third display element corresponding to the third work machine at the third location on the map display.

4. The method of claim 3 wherein detecting user interaction further comprises:
detecting a user interaction with the third display element on the map display, the user interaction with the third display element indicative of a selection input selecting the third work machine as part of a set of selected work machines including at least the second work machine and the third work machine; and
detecting a call initiation user input
controlling the communication system at the first work machine to communicate with the communication system at the second work machine and to communicate with a communication system of the third work machine based on the call initiation user input.

5. (canceled)

6. The method of claim 1 wherein detecting a second location of the second work machine comprises:
obtaining coordinates of the second work machine in a coordinate system.

7. The method of claim 1 wherein detecting a second location of the second work machine comprises:
detecting a location of the second work machine relative to the first work machine.

8. The method of claim 1 wherein causing display of the first display element and the second display element comprises:
causing display, as the first display element, a first pictorial representation of the first work machine; and
causing display, as the second display element, a second pictorial representation of the second work machine.

9. The method of claim 1 wherein causing display of the first display element and the second display element comprises:
causing display, as the first display element, operator information corresponding to an operator of the first work machine; and
causing display, as the second display element, operator information corresponding to an operator of the second work machine.

10. The method of claim 1 wherein causing display of the first display element and the second display element comprises:
causing display, as the first display element, a machine characteristic corresponding to the first work machine; and
causing display, as the second display element, a machine characteristic corresponding to the second work machine.

11. The method of claim 1 wherein controlling a communication system at the first work machine to communicate with a communication system at the second work machine comprises:
controlling the communication system at the first work machine to send a pre-defined message to the communication system at the second work machine.

12. The method of claim 1 wherein causing display comprises:
causing display on a display device mounted in an operator compartment of the first work machine.

13. The method of claim 1 wherein causing display comprises:
causing display on a display screen of a mobile device at the first work machine.

14. An operator interface system, comprising:
a machine locator system configured to identify a first location corresponding to a first work machine and a second location corresponding to a second work machine;
a display generator configured to generate a display, of a first display element corresponding to the first work machine at the first location on a map display and a second display element corresponding to the second work machine at the second location on the map display;
a user interaction detector configured to detect a user interaction with the second display element, the user interaction indicative of a selection input selecting the second work machine;
a machine selection display system configured to generate a display of a selection indicator display element on the map display based on the detected user interaction with the second display element, the selection indicator display element displayed at a location on the map to indicate correspondence with the second display element; and
a control signal generator generating a communication control signal to control a communication system to communicate with a communication system at the second work machine.
detecting a user interaction with the second display element on the map display, the user interaction indicative of a selection input selecting the second work machine

15. The operator interface system of claim 14 wherein the display generator comprises:
a communication functionality display system configured to display a user actuatable communication actuator, the control signal generator being configured to generate the communication control signal to control the communication system at the first work machine to communicate with the communication system at the second work machine based on user actuation of the user actuatable communication actuator.

16. The operator interface system of claim 14 wherein the machine locator is configured to identify a third location of a third work machine, the display generator being configured to display a third display element corresponding to the third work machine at the third location on the map display, the user interaction detector being configured to detect a user selection input selecting at least one of the second display element and the third display element to obtain a set of selected work machines and to detect a call initiation user input.

17. The operator interface system of claim 16 wherein the control signal generator is configured to generate the communication control signal to control the communication system on the first work machine to communicate with communication systems on each work machine in the set of selected work machines.

18. The operator interface system of claim 14 wherein the display generator comprises:
a machine display system configured to display, as the first display element, a first graphical representation of the first work machine and, as the second display element, a second user selectable graphical representation of the second work machine.

19. A method, comprising:
displaying a display element corresponding to a first work machine at a location on a map display that displays an off-road worksite;
detecting a user interaction with the display element on the map display of the off-road worksite, the user interaction indicative of a selection input selecting the first work machine;
causing display of a selection indicator display element on the map display of the off-road worksite based on the detected user interaction with the display element; and
controlling a communication system to communicate with a communication system at the first work machine.

20. The method of claim 19 wherein displaying comprises displaying a plurality of display elements each display element corresponding to a different work machine, of a plurality of different work machines, and each display element being displayed at a location, on the map display, of the corresponding work machine, wherein detecting comprises detecting, as the user interaction, a user selection input selecting a subset of the plurality of display elements corresponding to a subset of the plurality of work machines, and wherein controlling comprises: controlling the communication system to communicate with communication systems in the subset of the plurality of work machines.

21. The method of claim 19 and further comprising:
display an additional display element corresponding to a second work machine at an additional location on the map display of the off-road worksite,
causing display of an indicator display element on the map display of the off-road work site that indicates that the second work machine has not been selected.
